(19) United States
(12) Patent Application Publication
(10) Pub. No.: US 2017/0308575 A1
(43) Pub. Date: Oct. 26, 2017

(54) Method and Plan Optimizing Apparatus for Optimizing Query Execution Plan

(71) Applicant: Huawei Technologies Co., Ltd., Shenzhen (CN)

(72) Inventors: Dilip Kumar, Shenzhen (CN); Kumar Rajeev Rastogi, Bangalore (IN); Prasanna Venkatesh Ramamurthi, Bangalore (IN)

(21) Appl. No.: 15/648,210

(22) Filed: Jul. 12, 2017

Related U.S. Application Data
(63) Continuation of application No. PCT/CN2016/076377, filed on Mar. 15, 2016.

(30) Foreign Application Priority Data
Mar. 16, 2015 (IN) IN1300/CHE/2015

(51) Int. Cl. G06F 17/30

(52) U.S. Cl. CPC G06F 17/30463

(57) ABSTRACT

A method for optimizing query execution comprises receiving one or more optimizing parameters from a user device for optimizing a query execution plan. The one or more optimizing parameters comprise at least one of a query statement, a planning time and a plan execution time. The one or more optimizing parameters are received when duration of execution of the one or more queries using the query execution plan is greater than a predefined time period required for executing the one or more queries. The query execution plan is latest of one or more query execution plans for executing one or more queries. The method comprises generating an optimized query execution plan by iterating optimization of the query execution plan until the optimization satisfies the one or more optimizing parameters.

### CROSS-REFERENCE TO RELATED APPLICATIONS

This application is a continuation of International Application No. PCT/CN2016/076377, filed on Mar. 15, 2016, which claims priority to India Patent Application No. IN1300/CHE/2015, filed on Mar. 16, 2015. The disclosures of the aforementioned applications are hereby incorporated by reference in their entireties.

### TECHNICAL FIELD

The present disclosure relates to the field of database, and in particular, to a method and a plan optimizing apparatus for optimizing query execution plans.

### BACKGROUND

Generally, a Structured Query Language (SQL) is a kind of database query and programming language. A SQL statement inputted by a user is executed on a Relational Database Management System (RDBMS) database using an executor. The executor, in general, can execute wide range of queries which comprises, without limitations, join operations, grouping operations, trigger operations, functional execution in qualifications etc. The executor comprises a plurality of query execution plans using which the SQL statement is executed. Typically, each of the plurality of query execution plans comprises a planning time and an execution time. The planning time refers to a time required for planning or creating a query execution plan for executing the SQL statement. The execution time is a time required for executing the query execution plan towards the SQL statement. Based on the planning time and/or the execution time, the executor chooses a best plan among the plurality of query execution plans for executing the SQL statement.

In conventional approach, sometimes planning time and/or the execution time of the chosen query execution plan are huge. Particularly, the planning time required to create the query execution plan to execute the SQL statement having more number of join operations requires more time and involves complexity. In such a case, the execution process has to wait till the query execution plan is planned or created totally. In other words, the execution does not start until the query execution plan is created. Therefore, the execution of the SQL statement is prolonged because of waiting for the creation and execution of the query execution plan. Sometimes, the planning time can be more than the execution time to execute the query.

In another conventional approach, there exists a challenge to enhance the query execution plan while executing the query execution plan. For enhancing the query execution plan, there is a requirement to create the query execution plans from beginning which results in wastage of time and resources. Further, the creation of the query execution plan is always bound to planning time but is not bound to the execution time. For example, there is a challenge in creating or planning the query execution plan until the execution time reaches ‘X’. Thus, the conventional approaches lack flexibility in planning the query execution plan.

### SUMMARY

The objective of the present disclosure is to manage planning time and/or execution time to manage execution of queries. Another objective of the present disclosure is to optimize the planning time and/or the execution time along with optimization of the query execution plan. The optimization is performed until an optimized query execution plan is generated depending on an optimized planning time and/or execution time.

The present disclosure relates to a method for optimizing query execution plan. The method comprises receiving one or more optimizing parameters from a user device for optimizing a query execution plan, wherein the query execution plan is latest of one or more query execution plans for executing one or more queries and generating an optimized query execution plan by iterating optimization of the query execution plan until the optimization satisfies the one or more optimizing parameters.

Embodiments of the present disclosure further disclose that the one or more optimizing parameters comprise at least one of a query statement, a planning time and a plan execution time. The method comprises receiving the one or more optimizing parameters when duration of execution of the one or more queries using the query execution plan is greater than a predefined time period required for executing the one or more queries. In an embodiment, the query execution plan is stored in a memory associated to the plan optimizing apparatus. The method further comprises storing the optimized query execution plan as a latest plan in the memory of the plan optimizing apparatus for executing the one or more queries. In an embodiment, the one or more query execution plans are generated upon receiving a plan creation request from the user device. The plan creation request comprises at least one of a query statement, a query and the one or more optimizing parameters.

A plan optimizing apparatus is disclosed in the present disclosure for optimizing query execution plan. The plan optimizing apparatus comprises a receiving module, a plan optimizing module, a memory, a plan generating module and an update module. The receiving module is configured for receiving one or more optimizing parameters from a user device for optimizing a query execution plan. The one or more optimizing parameters comprise a query statement, a planning time and a plan execution time. The receiving module receives the one or more optimizing parameters when duration of execution of the one or more queries using the query execution plan is greater than a predefined time period required for executing the one or more queries. The query execution plan is latest of one or more query execution plans for executing one or more queries. The one or more query execution plans are generated by the plan generating module upon receiving a plan creation request from the user device. The plan creation request comprises a query statement, a query and the one or more optimizing parameters. The memory stores the query execution plan being received. The plan optimizing module is configured for generating an optimized query execution plan by iterating optimization of the query execution plan until the optimization satisfies the one or more optimizing parameters. The update module is configured for storing the optimized query execution plan as a latest plan in the memory of the plan optimizing apparatus for executing the one or more queries.

The present disclosure relates to a non-transitory computer readable medium including operations stored thereon that when processed by at least one processing unit cause a plan optimizing apparatus to perform one or more actions by performing the acts of receiving one or more optimizing parameters from a user device for optimizing a query execution plan, wherein the query execution plan is latest of one or more query execution plans for executing one or more queries, and generating an optimized query execution plan by iterating optimization of the query execution plan until the optimization satisfies the one or more optimizing parameters.

A computer program for performing one or more actions on a plan optimizing apparatus is disclosed by the present disclosure. The computer program comprises code segment for receiving one or more optimizing parameters from a user device for optimizing a query execution plan. The query execution plan is latest of one or more query execution plans for executing one or more queries. The computer program comprises code segment for generating an optimized query execution plan by iterating optimization of the query execution plan until the optimization satisfies the one or more optimizing parameters.

In an embodiment, the present disclosure provides advantage of optimizing the query execution plan including optimization of planning time and/or execution time. The present disclosure provides optimization of the query execution plan until the planning time and/or the execution time is satisfied. Particularly, the query execution plan which is currently in usage for executing the queries is further enhanced till the planning time and/or the execution time expires. In this way, there is no need to create a new plan from beginning and thus time is saved. Instead, an old plan itself is enhanced till a best query execution plan is generated. Thus, the time is not wasted in creating the query execution plan from beginning and also the best query execution plan is created to execute the queries quickly and efficiently without delay. Also, the present disclosure reduces the planning time and/or the execution time to reduce duration of the execution of the queries.

The foregoing summary is illustrative only and is not intended to be in any way limiting. In addition to the illustrative aspects and features described above, further aspects, and features will become apparent by reference to the drawings and the following detailed description.

### BRIEF DESCRIPTION OF THE DRAWINGS

The novel features and characteristic of the present disclosure are set forth in the appended claims. The embodiments of the present disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings.

FIG. 1 shows an exemplary block diagram illustrating a plan optimizing apparatus with processor and memory in accordance with some embodiments of the present disclosure.

FIG. 2 shows exemplary block diagram illustrating a plan optimizing apparatus with various data and modules for optimizing query execution plan in accordance with some embodiments of the present disclosure.

FIG. 3 illustrates flowchart of method for optimizing query execution plan in accordance with some embodiments of the present disclosure.

FIG. 4 illustrates a block diagram of an exemplary computer system for implementing embodiments consistent with the present disclosure.

The figures depict embodiments of the present disclosure for purposes of illustration only. One skilled in the art will readily recognize from the following description that alternative embodiments of the structures and methods illustrated herein may be employed without departing from the principles of the present disclosure described herein.

### DETAILED DESCRIPTION

The foregoing has broadly outlined the features and technical advantages of the present disclosure in order that the detailed description of the present disclosure that follows may be better understood. Additional features and advantages of the present disclosure will be described hereinafter which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Embodiments of the present disclosure relate to optimization of query execution plans. A plan creation request is received to create a query execution plan for usage in executing queries inputted by a user. The plan creation request is received along with a query. Each time a new query is inputted, a query execution plan is generated. A query execution plan is a latest plan among the one or more query execution plans which is recently generated for optimizing the execution of the query. Particularly, the one or more query execution plans are created one after the other for optimizing the execution of the query. Thus, a query execution plan which is recently used is considered to be the latest plan among the one or more query execution plans. The optimization is performed using a query statement, a planning time and an execution time. The planning time refers to a time required to plan the optimization of the query execution plan. The execution time refers to a time required to execute the optimized query execution plan. The optimization of the query execution plan is iterated to create an optimized query execution plan until the planning time and/or the execution time is satisfied. In this way, a best optimized query execution plan is created to optimize the execution of the query.

Henceforth, embodiments of the present disclosure are explained with the help of exemplary diagrams and one or more examples. However, such exemplary diagrams and examples are provided for the illustration purpose for better understanding of the present disclosure and should not be construed as limitation on scope of the present disclosure.

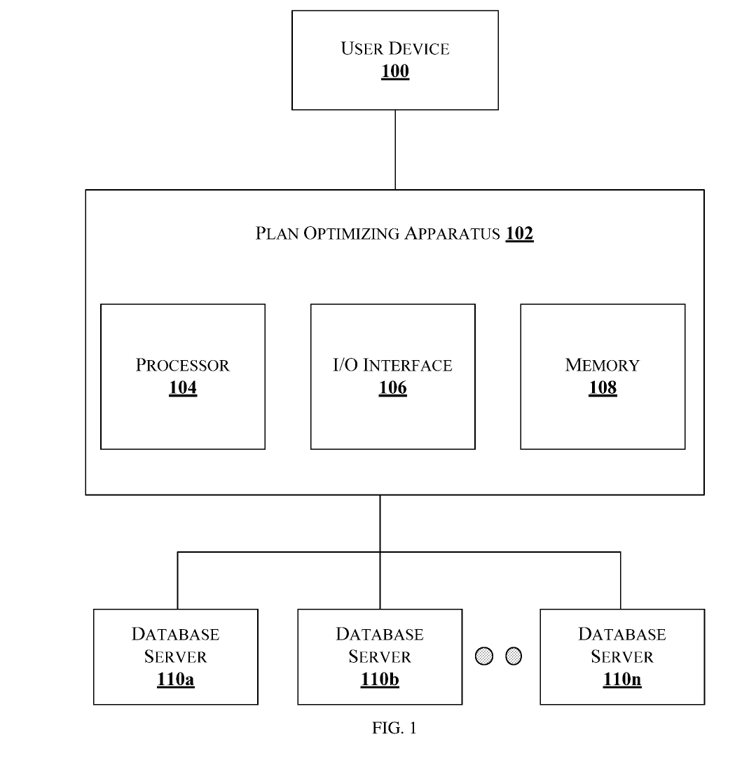

FIG. 1 shows an exemplary block diagram illustrating a plan optimizing apparatus 102 with a processor 104 and a memory 108 in accordance with some embodiments of the present disclosure.

The plan optimizing apparatus 102 is configured to optimize query execution plans. In an embodiment, the plan optimizing apparatus 102 is communicatively connected to a user device 100 and one or more database servers 110a, 110b, . . . , 110n (collectively referred to 110). In one implementation, the user device 100 may be implemented in a variety of computing systems, such as a laptop computer, a desktop computer, a notebook, a workstation, a mainframe computer, a server, a network server, and the like. The user device 100 can be used by a user which may include a person or device itself capable performing such actions performed by the user. The user includes, but is not limited to, an administrator, a developer, a tester, a manager, an editor, an Information Technology (IT) personnel, Business Intelligence (BI) specialists, data scientists etc. In an embodiment, the user device 100 enables the user to input one or more queries, and one or more optimization parameters. The user device 100 comprises a user interface (not shown) to display results of execution of a query execution plan for a query of the one or more queries. The user can input the one or more queries, and the one or more optimization parameters through the user interface. Additionally, the user interface displays iterations of optimization of a query execution plan to create an optimized query execution plan. FIG. 1 shows only one user device 100 for illustration purpose. However, a person skilled in the art would understand that there can be ‘n’ number of user devices connected to the plan optimizing apparatus 102.

The one or more database servers 110 are associated to one or more databases which are used for providing query results in response to the one or more queries received from the user device 100. In an exemplary embodiment, the one or more databases include, but are not limited to, a RDBMS database, an SQL based database and Not Only SQL (NoSQL) database. In an embodiment, the one or more databases are used for fetching the query results using an executor (not shown) of the one or more database servers 110.

The plan optimizing apparatus 102 may include at least one central processing unit (“CPU” or “processor”) 104, an input/output (I/O) interface 106, and a memory 108. In an embodiment, the I/O interface 106 is an interface through which one or more input data and output data is received and provided respectively. The I/O interface 106 is configured to receive the one or more queries from the user device 100. The I/O interface 106 is configured to provide a result of the execution of the query execution plan towards executing the query for display. The I/O interface 106 is configured to provide the query results or query data fetched from the one or more database to the user device 100. Further, the I/O interface 106 is configured to receive the one or more optimizing parameters from the user device 100 or from the plan optimizing apparatus 102 itself. The result of iteration of optimization of the query execution plan along with the optimized query execution plan is provided for display to the user device 100 through the I/O interface 106. In an embodiment, the result of the execution of the query execution plan, the optimized query execution plan and the result of iteration of optimization of the query execution plan can be provided for display to a user interface associated to the plan optimizing apparatus 102. In an embodiment, the I/O interface 106 is coupled to the processor 104.

The processor 104 may comprise at least one data processor for executing program components for executing user- or device-generated queries and optimizing parameters. The processor 104 is configured to execute the one or more queries received through the I/O interface 106. In an embodiment, the processor 104 is configured for executing the query using the query execution plan and fetching the query results from the one or more databases through the one or more database servers 110. The processor 104 is configured to generate the query execution plan based on the plan creation request. The processor 104 is further configured to optimize the query execution plan called as latest plan which is recently been generated among the one or more query execution plans. In particular, the processor 104 is configured to optimize the query execution plan i.e. the latest plan using the one or more optimizing parameters. The processor 104 is configured to iterate the optimization of the query execution plan till the one or more optimizing parameters is satisfied. In one implementation, more than one query execution plan can be optimized by the processor 104. In an embodiment, the processor 104 performs the optimization by using one or more data and implementing and executing one or more modules.

The memory 108 is communicatively coupled to the processor 104. The memory 108 stores processor-executable instructions which on execution cause the processor 104 to perform the optimization of the query execution plan i.e. the latest plan. The memory 108 stores the one or more query execution plans created by the processor 104. The memory 108 stores the optimized query execution plan as a latest plan i.e. a next latest plan for executing the one or more queries. Further, the memory 108 stores the one or more data and the one or more modules which are explained in detail in following description of the present disclosure.

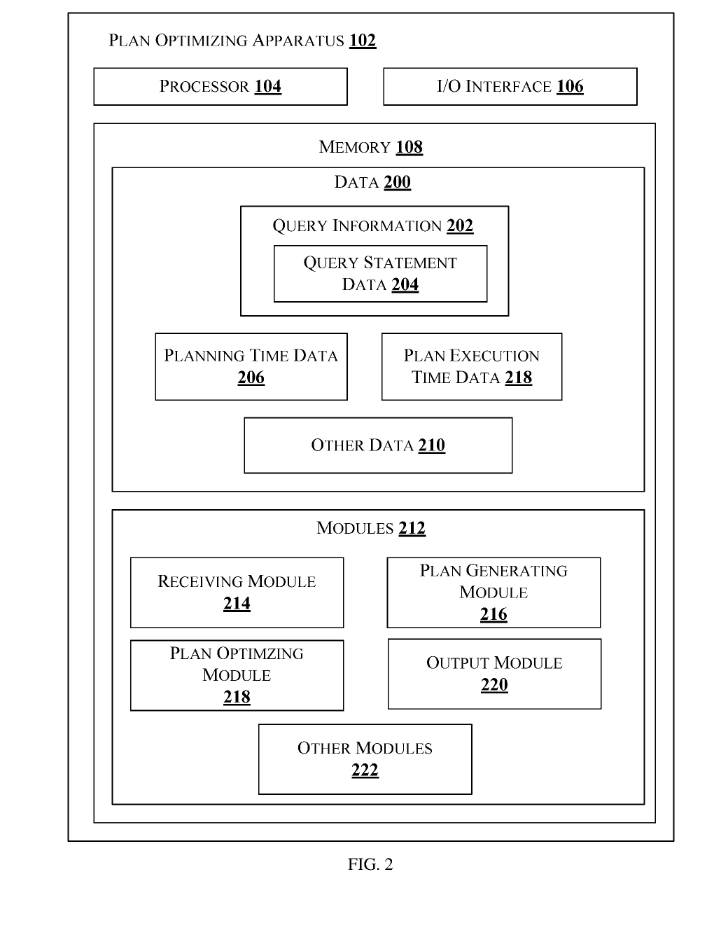

FIG. 2 shows exemplary block diagram illustrating the plan optimizing apparatus 102 with the one or more data 200 and the one or more modules 212 for optimizing the query execution plan in accordance with some embodiments of the present disclosure.

In an embodiment, the one or more data 200 may include, for example, query information 202, query statement data 204, planning time data 206, plan execution time data 208 and other data 210 received from the user device 100 for optimizing the query execution plan.

The query information 202 comprises details of a query and a query statement which are received when the query is received from the user device 100. The query information 202 may comprise the plan creation request including a query and a query statement data 204 for creating the query execution plan for the query. For example, consider the user raise a query ‘Q’. Upon the raising the query ‘Q’ by the user device 100, the plan creation request for creating the query execution plan for the query ‘Q’ is received by the plan optimizing apparatus 102. In an embodiment, the plan creation request comprises a query for example ‘Q’ and a query statement defining the query ‘Q’. For example, the processor 104 creates a query execution plan ‘P1’ for the query ‘Q’ based on the plan creation request. An example of the query statement standard for six table join is as below:

```
  SELECT n_name, sum (l_extendedprice * (1 - l_discount)) as revenue
  FROM
  customer, orders, lineitem, supplier, nation, region
  where
    c_custkey = o_custkey and l_orderkey = o_orderkey and l_suppkey =
    s_suppkey and c_nationkey = s_nationkey and s_nationkey =
    n_nationkey and n_regionkey
  = r_regionkey
  and r_name = ′abc′/*′:1′*/ and o_orderdate >= timenow( ) and
o_orderdate < timenow ( ) + interval ′1 year′
  group by n_name order by revenue desc;
```

In an embodiment, the plan creation request may also comprise a plan time and an execution time. The plan time refers to time for planning or creating an optimized query execution plan for the query ‘Q’ or time required to plan the optimization of the query execution plan. The execution time refers to time for executing the optimized query execution plan for executing the query ‘Q’. In an embodiment, the query execution ‘P1’ is considered to be a latest plan or suboptimal plan among the one or more query execution plans. The one or more query execution plans were created one after the other for optimizing the execution of the query ‘Q’. The query execution plan ‘P1’ is the latest plan or suboptimal plan. In an embodiment, the query execution plan can be created using only the query and the query statement. The usage of the plan time and the execution time for creating the query execution plan are optional.

The data 200 comprises optimizing parameters data (not shown) which are used as the one or more optimizing parameters for optimizing the query execution plan. The optimizing parameters data includes the query statement data 204, the planning time data 206 and the plan execution time data 208. The query statement data 204 refers to the query statement of the query. For example, considering, the query execution plan ‘P1’ contains 100 statements of programming instructions. In view of the result of execution of the query execution plan ‘P1’, assuming the execution is taking duration more than a predefined time period. The predefined time period is a time period within which the execution must have been completed. For instance, predefine time period may be considered to be one hour. With the viewing initially, the execution is taking more duration at 14^{th} statement of the query execution plans ‘P1’. Therefore, the user device 100 wants to optimize the query execution plan ‘P1’ from the 14^{th} statement of the programming instructions for the query ‘Q’. Hence, the user device 100 specifies the query statement as below:

Enhance Plan(14,30 m,15 m) (1)

The planning time data 206 refers to a time for creating or planning the optimization of the query execution plan ‘P1’ i.e. for creating an optimized query execution plan from ‘P1’ to ‘P1*’. For example, the user device 100 specifies the planning time as 30 minutes for creating the optimized query execution plan as ‘P1*’ by optimizing the query execution plan ‘P1’ commencing from the 14^{th} statement. The exemplary instruction for creating the enhanced or optimized the query execution plan ‘P1*’ for the query ‘Q’ with 30 minutes is stated as below:

Enhance Plan(14,30 m) (2)

The optimization commencing from the 14^{th} statement of the query execution plan ‘P1’ is initiated and executed till the planning time of 30 minutes expires. Further, the optimization is iterated repeatedly until the optimization results with a best execution plan as per the satisfaction of the planning time.

The plan execution time data 208 refers to a time for executing the optimized query execution plan ‘P1*’ for the query ‘Q’. For example, the execution time is specified as 15 minutes for executing the optimized query execution plan as ‘P1*’. The execution of the optimized query execution plan ‘P1*’ commences from the 14^{th} statement. The exemplary instruction for executing the enhanced or optimized query execution plan ‘P1*’ for the query ‘Q’ with the plan execution time as 15 minutes is stated as below:

Enhance Plan(14,30 m,15 m) (3)

The execution commencing from the 14^{th} statement of the optimized query execution plan ‘P1*’ is initiated and executed till the plan execution time of 15 minutes expires. Further, the optimization is iterated repeatedly until the optimization results with a best execution plan as per the satisfaction of the plan execution time.

In an embodiment, the optimization can be performed until either or both of the planning time and the plan execution time expires.

The other data 210 may refer to such data which can be used for optimization of the query execution plan ‘P1’.

In an embodiment, the one or more data 200 in the memory 108 are processed by the one or more modules 212 of the plan optimizing apparatus 102. The one or more modules 212 may be stored within the memory 108 as shown in FIG. 2. In an example, the one or more modules 212, communicatively coupled to the processor 104, may also be present outside the memory 108. Particularly, the one or more data 200 in the memory 108 including the one or more optimizing parameters are used by the one or more modules 212. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

The one or more modules 212 may include, for example, a receiving module 214, a plan generating module 216, a plan optimizing module 218, and an output module 220. Other modules 222 to perform various miscellaneous functionalities of the optimization of the query execution plan are included in the modules 212. It will be appreciated that such aforementioned modules may be represented as a single module or a combination of different modules.

The receiving module 212 is configured to receive the one or more queries. Below (4) shows a plan create request statement for creating the query execution plan ‘P1’ for the query e.g. ‘Q’:

Prepare(query stmt,“query”,planning time,plan execution time) (4)

The plan generating module 216 is configured to generate the query execution plan ‘P1’ for the query ‘Q’.

The plan optimizing module 218 generates an optimized query execution plan ‘P1*’ by iterating optimization of the query execution plan ‘P1’ until the optimization satisfies the one or more optimizing parameters. For example, considering, ‘P1’ is the query execution plan which is used as the latest plan or suboptimal plan to execute the query ‘Q’. The query execution plan ‘P1’ contains 100 statements of programming instructions. In view of the result of execution of the query execution plan ‘P1’, assuming the execution is taking duration more than a predefined time period within which the execution must have been completed. Particularly, with the viewing initially, the execution is taking more duration at 14^{th} statement of the query execution plan ‘P1’. Therefore, the user wants to optimize the planning and plan execution time for executing the query ‘Q’ commencing from the 14^{th} statement. Hence, the user device 100 specifies the optimizing parameters as below:

Enhance Plan(query stmt,planning time,plan execution time) (5)

In an embodiment, the plan optimizing apparatus 102 uses a simulated annealing technique and/or a generic technique for optimizing the query execution plan ‘P1’. Thus, the optimized query execution plan ‘PP’ is generated by iterating optimization of the query execution ‘P1’ till the planning time and/or the execution time expires or till the best plan is created.

In an embodiment, the optimized query execution plan ‘P1*’ is stored in the memory 108. Particularly, the optimized query execution plan ‘PP’ is stored as a latest plan in the memory 108 for executing the one or more queries in next cycle or in next execution process.

The output module 220 is configured to provide one or more output data for display. The output data includes, but is not limited to, the result of the execution of the query execution plan ‘P1’, the generation of the optimized query execution ‘PP’ and the iterations of optimization of the query execution plan ‘P1’ to create the optimized query execution plan ‘P1*’.

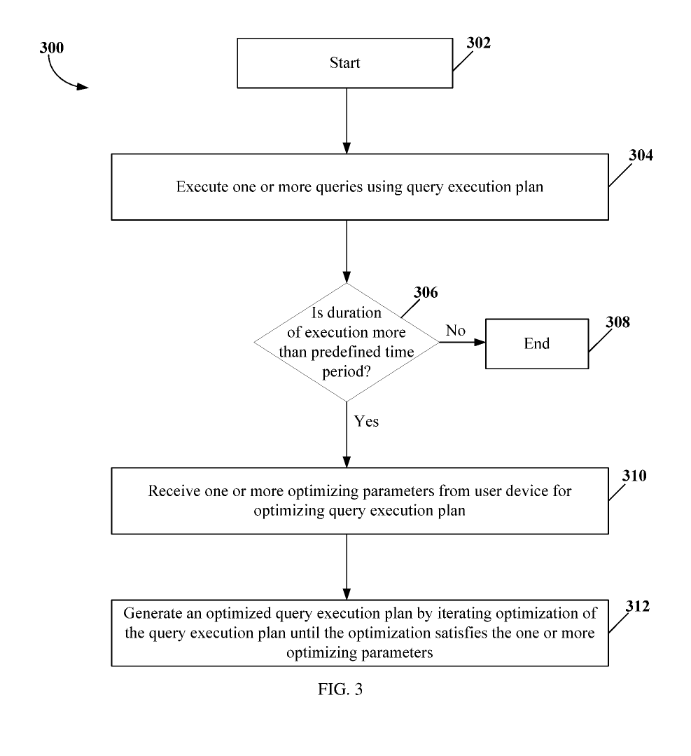

FIG. 3 illustrates a flowchart of method 300 for optimizing the query execution plan ‘P1’ in accordance with some embodiments of the present disclosure.

As illustrated in FIG. 3, the method 300 comprises one or more blocks for optimizing the query execution plan. The method 300 may be described in the general context of computer executable instructions. Computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the scope of the subject matter described herein. Furthermore, the method 300 can be implemented in any suitable hardware, software, firmware, or combination thereof.

At block 302, the process of execution of the one or more queries starts.

At block 304, the one or more queries received from the user device 100 is executed using the query execution plan ‘P1’ among the one or more query execution plans created in past. In an embodiment, the query execution plan ‘P1’ is created based on the plan creation request of the one or more queries. For example, let ‘P1’ be the query execution plan created for the query ‘Q’. And let the query execution plan ‘P1’ be the latest query execution plan which is recently or currently in usage for executing the query ‘Q’.

At block 306, a condition is checked whether the time taken for execution of the query execution plan is more than the predefined time period within which the execution was expected to be completed. For example, considering, the query execution plan ‘P1’ contains 100 statements of programming instructions. In view of the result of execution of the query execution plan ‘P1’, For example, assuming the execution time goes to 1 hour and 30 minutes whereas the predefined time period for the execution was expected to be 1 hour. Particularly, with the viewing initially, the execution is taking more duration at 14^{th} statement of the query execution plan ‘P1’. If the execution of the query execution plan is not more than the predefined time period, then the process goes to block 308 via ‘No’ where the process for optimization is not performed and the query is executed in traditional way. If the execution of the query execution plan is more than the predefined time period, then the process goes to block 310 via ‘Yes’.

At block 310, the one or more optimizing parameters comprising the query statement, the planning time and the plan execution time is received from the user device 100 for optimizing a query execution plan ‘P1’. For example, the one or more optimizing parameters are used on the query execution plan ‘P1’ for optimizing the query execution plan ‘P1’. In an embodiment, the one or more optimizing parameters are applied to optimize the query execution plan ‘P1’ commencing from the 14^{th} statement of the programming instructions of the query execution plan ‘P1’.

At block 312, the optimized query execution plan ‘P1*’ is generated by iterating optimization of the query execution plan ‘P1’ until the optimization satisfies the one or more optimizing parameters. The iteration is initiated commencing where the condition of execution is checked. For example, the iteration is initiated commencing from the 14^{th} statement of the programming instructions of the query execution plan ‘P1’. In an embodiment, the iteration is performed until the best execution plan is generated. In an embodiment, the iteration is performed until the planning time and/or the plan execution time expires.

Computer System

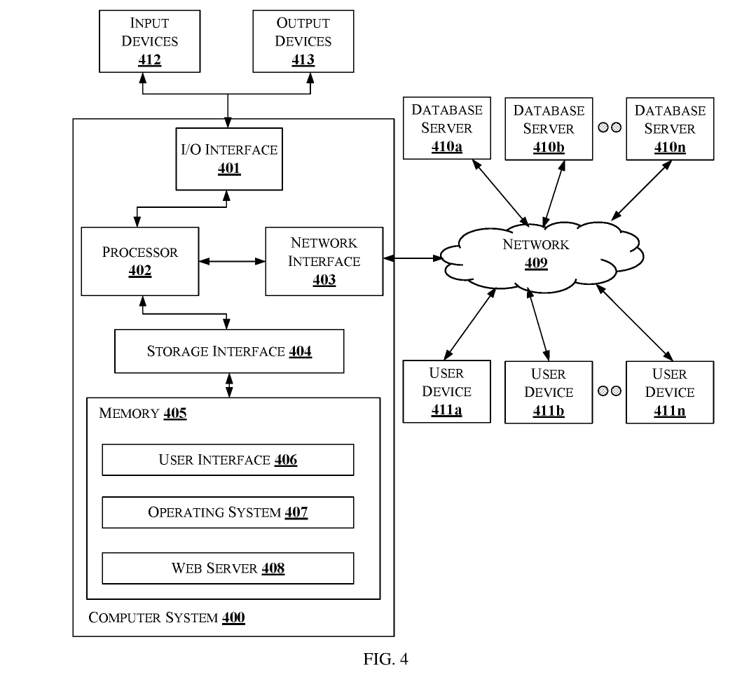

FIG. 4 illustrates a block diagram of an exemplary computer system 400 for implementing embodiments consistent with the present disclosure. In an embodiment, the computer system 400 is used to implement the plan optimizing apparatus 102. The computer system 400 may comprise a processor 402. The processor 402 may comprise at least one data processor for executing program components for generating an optimized query execution plan. The processor 402 may include specialized processing units such as integrated system (bus) controllers, memory management control units, floating point units, graphics processing units, digital signal processing units, etc.

The processor 402 may be disposed in communication with one or more I/O devices (412 and 413) via I/O interface 401. The I/O interface 401 may employ communication protocols/methods such as, without limitation, audio, analog, digital, monoaural, Radio Corporation of America (RCA), stereo, Institute of Electrical and Electronics Engineers (IEEE)-1394, serial bus, universal serial bus (USB), infrared, personal system (PS)/2, Bayonet Neill-Concelman (BNC), coaxial, component, composite, digital visual interface (DVI), high-definition multimedia interface (HDMI), radio frequency (RF) antennas, separate (S)-Video, video graphics array (VGA), IEEE 802.n/b/g/n/x, BLUETOOTH, cellular (e.g., code-division multiple access (CDMA), high-speed packet access (HSPA+), global system for mobile communications (GSM), long-term evolution (LTE), WiMax, or the like), etc.

The I/O interface(s) 401 may include a variety of software and hardware interfaces, for example, a web interface, a graphical user interface, etc. Using the I/O interface 401, the computer system 400 may communicate with one or more I/O devices (412 and 413). For example, the input device 412 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. The output device 413 may be a printer, fax machine, video display (e.g., cathode ray tube (CRT), liquid crystal display (LCD), light-emitting diode (LED), plasma, or the like), audio speaker, etc.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with one or more database servers 410 (a, . . . n) and one or more user devices 411 (a, . . . , n). The one or more database servers 410 (a, . . . , n) includes, but not limited to, relational database i.e. RDBMS, an SQL based database and the NOSQL database. The one or more user devices 411 (a, . . . , n) may include, without limitation, personal computer(s), server(s), fax machines, printers, scanners, various mobile devices such as cellular telephones, smartphones, tablet computers, eBook readers, laptop computers, notebooks, gaming consoles, or the like. In an embodiment, one or more queries is received from the one or more user devices 411 (a, . . . , n) which may be used by various stakeholders, IT administrators, business analyst, software tester, software developer or end users of an organization.

In some embodiments, the processor 402 may be disposed in communication with a memory 405 (e.g., random access memory (RAM), read-only memory (ROM), etc. not shown in FIG. 4) via a storage interface 404. The storage interface 404 may connect to memory 405 including, without limitation, memory drives, removable disc drives, etc., employing connection protocols such as serial advanced technology attachment (SATA), integrated drive electronics (IDE), IEEE-1394, USB, fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 405 may store a collection of program or database components, including, without limitation, user interface application 406, an operating system 407, web server 408 etc. In some embodiments, computer system 400 may store user/application data 406, such as the data, variables, records, etc. as described in this disclosure. Such databases may be implemented as fault-tolerant, relational, scalable, secure databases such as ORACLE or SYBASE.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FREEBSD, NETBSD, OPENBSD, etc.), LINUX distributions (e.g., RED HAT, UBUNTU, KUBUNTU, etc.), INTERNATIONAL BUSINESS MACHINES (IBM) operating system (OS)/2, MICROSOFT WINDOWS (XP, VISTA/7/8, etc.), APPLE IOS, GOOGLE ANDROID, BLACKBERRY OS, or the like. User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical user interfaces (GUIs) may be employed, including, without limitation, APPLE MACINTOSH operating systems' AQYA, IBM OS/2, MICROSOFT WINDOWS (e.g., AERO, METRO, etc.), UNIX X-WINDOWS, web interface libraries (e.g., ACTIVEX, JAVA, JAVASCRIPT, AJAX, Hyper-Text Markup Language (HTML), ADOBE FLAHS, etc.), or the like.

In some embodiments, the computer system 400 may implement a web browser 408 stored program component. The web browser 408 may be a hypertext viewing application, such as MICROSOFT INTERNET EXPLORER, GOOGLE CHROME, MOZILLA FIREFOX, APPLE SAFARI, etc. Secure web browsing may be provided using HTTPS (secure hypertext transport protocol), secure sockets layer (SSL), Transport Layer Security (TLS), etc. Web browsers may utilize facilities such as AJAX, Dynamical HTML (DHTML), ADOBE FLASH, JAVSCRIPT, JAVA, application programming interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ACTIVEX, American National Standards Institute (ANSI) C++/C#, MICROSOFT .NET, common gateway interface (CGI) scripts, JAVA, JAVASCRIPT, practical extraction and report language (PERL), hypertext preprocessor (PHP), PYTHON, WEBOBJECTS, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 400 may implement a mail client stored program component. The mail client may be a mail viewing application, such as APPLE MAIL, MICROSOFT ENTOURAGE, MICROSOFT OUTLOOK, MOZILLA THUNDERBIRD, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, nonvolatile memory, hard drives, compact disc (CD) ROMs, digital video disc (DVDs), flash drives, disks, and any other known physical storage media.

In one implementation, the computer system 400 is configured to communicate with the one or more databases 410 (a, . . . , n) and the one or more user devices 411 (a, . . . , n) over a network 409 through a network interface 403. The network includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The network may either be a dedicated network or a shared network, which represents an association of the different types of networks that use a variety of protocols, for example, Hypertext Transfer Protocol (HTTP), TCP/IP, Wireless Application Protocol (WAP), etc., to communicate with each other. Further, the network may include a variety of network devices, including routers, bridges, servers, computing devices, storage devices, etc. The network interface 403 may employ connection protocols include, but not limited to, direct connect, Ethernet (e.g., twisted pair 10/100/1000 Base T), TCP/IP, token ring, IEEE 802.11a/b/g/n/x, etc.

Additionally, advantages of present disclosure are illustrated herein.

Embodiments of the present disclosure relate to managing the planning time and/or the execution time to manage execution of the one or more queries.

Embodiments of the present disclosure relate to optimizing the planning time and/or the execution time along with optimization of the query execution plan. The optimization is performed until an optimized query execution plan is generated until the planning time and/or the execution time is satisfied. In this way, the present disclosure provides a best query execution plan which can execute the queries quickly and efficiently without delay.

Embodiments of the present disclosure reduce the planning time and/or the execution time to reduce duration of the execution of the one or more queries.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., electrically erasable programmable ROMs (EEPROMs), ROMs, programmable ROMs (PROMs), RAMs, dynamic RAM (DRAMs), static RAM (SRAMs), flash memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), ASIC, etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the disclosure, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for optimizing query execution plan, comprising:
receiving, by a plan optimizing apparatus, one or more optimizing parameters from a user device for optimizing a query execution plan, wherein the query execution plan is a latest of one or more query execution plans for executing one or more queries; and
generating, by the plan optimizing apparatus, an optimized query execution plan by iterating optimization of the query execution plan until the optimization satisfies the one or more optimizing parameters.

2. The method as claimed in claim 1, wherein the one or more optimizing parameters comprise at least one of a query statement, a planning time, or a plan execution time.

3. The method as claimed in claim 2, wherein the one or more optimizing parameters are received when a duration of an execution of the one or more queries using the query execution plan is greater than a predefined time period required for executing the one or more queries.

4. The method as claimed in claim 1, wherein the query execution plan is stored in a memory associated with the plan optimizing apparatus.

5. The method as claimed in claim 4, further comprising storing, by the plan optimizing apparatus, the optimized query execution plan as a latest plan in the memory of the plan optimizing apparatus for executing the one or more queries.

6. The method as claimed in claim 1, wherein the one or more query execution plans are generated upon receiving a plan creation request from the user device.

7. The method as claimed in claim 6, wherein the plan creation request comprises at least one of a query statement, a query, or the one or more optimizing parameters.

8. A plan optimizing apparatus for optimizing query execution plan comprising:
a receiver configured to receive one or more optimizing parameters from a user device for optimizing a query execution plan, wherein the query execution plan is a latest of one or more query execution plans for executing one or more queries; and
a processor coupled to the receiver and configured to generate an optimized query execution plan by iterating optimization of the query execution plan until the optimization satisfies the one or more optimizing parameters.

9. The plan optimizing apparatus as claimed in claim 8, wherein the one or more optimizing parameters comprise at least one of a query statement, a planning time, or a plan execution time.

10. The plan optimizing apparatus as claimed in claim 9, wherein the receiver is further configured to receive the one or more optimizing parameters when a duration of execution of the one or more queries using the query execution plan is greater than a predefined time period required for executing the one or more queries.

11. The plan optimizing apparatus as claimed in claim 8, further comprising a memory for storing the query execution plan.

12. The plan optimizing apparatus as claimed in claim 11, further comprising a memory configured to store the optimized query execution plan as a latest plan for executing the one or more queries.

13. The plan optimizing apparatus as claimed in claim 8, wherein the processor is further configured to generate the one or more query execution plans upon receiving a plan creation request from the user device.

14. The plan optimizing apparatus as claimed in claim 13, wherein the plan creation request comprises at least one of a query statement, a query, or the one or more optimizing parameters.

15. A non-transitory computer readable medium including operations stored thereon that when processed by at least one processor cause a plan optimizing apparatus to perform one or more actions by performing the acts of:
receiving one or more optimizing parameters from a user device for optimizing a query execution plan, wherein the query execution plan is a latest of one or more query execution plans for executing one or more queries; and
generating an optimized query execution plan by iterating optimization of the query execution plan until the optimization satisfies the one or more optimizing parameters.

16. A computer program for performing one or more actions on a plan optimizing apparatus, wherein the computer program comprises code segments for:
receiving one or more optimizing parameters from a user device for optimizing a query execution plan, wherein the query execution plan is a latest of one or more query execution plans for executing one or more queries; and
generating an optimized query execution plan by iterating optimization of the query execution plan until the optimization satisfies the one or more optimizing parameters.
